(19) United States
(12) Patent Application Publication
(10) Pub. No.: US 2024/0226975 A1
(43) Pub. Date: Jul. 11, 2024

(54) DEVICE AND METHOD FOR PROCESSING ORGANIC MATERIAL

(71) Applicant: DRANCO, naamloze vennootschap, Gent (BE)

(72) Inventors: Piet Lodewijk Magdalena Smis, Gavere (BE); Wesley Jenny Raymond Heylbroeck, Merelbeke (BE)

(21) Appl. No.: 18/558,781

(22) PCT Filed: May 5, 2022
(86) PCT No.: PCT/IB2022/054156

§ 371 Date: Nov. 3, 2023

(30) Foreign Application Priority Data
May 7, 2021 (BE) 2021/5374

(51) Int. Cl. B09B 3/65; B09B 3/20; B09B 3/80

(52) U.S. Cl. CPC B09B 3/65; B09B 3/20; B09B 3/80

(57) ABSTRACT

A device for processing organic material which may also contain elements with high density, the device being provided with a tank with a digestion space and an inlet for supplying the organic material to be processed The device is provided with at least two sealable outlets. One or more outlets are recycling outlets which are intended to discharge the at least partly digested organic material and at least one outlet is a residue outlet, which is intended for discharging at least a part of the indigestible elements with high density. The residue outlet being located at a lower level than the one or more recycling outlets.

### CROSS-REFERENCE TO RELATED APPLICATIONS

The present application is the National Phase entry of International Patent Application No. PCT/IB2022/054156 filed May 5, 2022, which claims priority to Belgium Patent Application No. 2021/5374 filed May 7, 2021, the entire contents of which are hereby incorporated by reference into this application.

### TECHNICAL FIELD

The present disclosure relates to a device and a method for processing organic material.

More specifically the present disclosure is intended for anaerobically digesting organic material, whereby elements with high density are separated.

### BACKGROUND

Various methods and installations are already known to anaerobically digest biodegradable organic material, whereby the organic material often contains relatively heavy elements with high density which are digested together with the organic fraction in the tank, after which the heavy elements together with the at least partly digested material are removed from the tank by an extraction system to subsequently be mixed with organic material to be digested in a mixing system, the mixture of which can be pumped back to the tank for digestion.

The aforementioned heavy elements can thus end up in the tank and go through the digestion process several times such that they may cause damage to the installation as well as accelerate the wear and tear of the extraction system and/or of the mixing system and/or of the pumps, which not only implies high costs but can also compromise business operations.

During the digesting process of the organic material, the heavy elements may sink to the bottom of the tank under the influence of gravity in the direction of the outlet and accumulate there.

A disadvantage of this is that blockages may occur on the level of the extraction system and/or the mixing system and/or the pumps.

The purpose of the present disclosure is to provide a solution to the aforementioned and other disadvantages.

### SUMMARY

To this end, the present disclosure relates to a device for processing organic material, whereby the organic material may also contain elements with high density, said device being provided with a tank with a digestion space and an inlet for supplying the organic material to be processed, whereby the device is provided with at least two sealable outlets, whereby one or more outlets are recycling outlets which are intended to discharge the at least partly digested organic material and at least one outlet is a residue outlet, which is intended for discharging at least a part of the indigestible elements with high density, said residue outlet being located on a lower level than the one or more recycling outlets and whereby the device contains a mixing pump for mixing the organic material to be digested with at least partly digested material and/or with external inoculum and for pumping the mixed mass via the inlet to the digestion space.

An aspect of this is that indigestible elements with high density can be discharged from the device relatively simply.

It is hereby possible that a quantity of at least partly digested material is discharged. However, the quantity of at least partly digested material that is lost is limited and, in some embodiments, minimal.

Another aspects is that the aforementioned elements are removed from the tank such that the elements can undergo a separate post-treatment and can cause no more damage to the device and there is also less wear and tear of the device.

Yet another aspect is that when discharging the elements with high density from the digestion space, in this way the average concentration of the aforementioned elements in the digestion space will decrease to a level lower than the average concentration of the aforementioned elements in the organic material to be digested, such that the risk of accumulations in the device and blockages is greatly reduced.

Consequently, the operational reliability of the device is strongly increased.

The device allows the digestible waste to be digested by a dry digestion and this both for a relatively high dry matter percentage in the digestion space, thus with a high viscosity, and a low dry matter percentage in the digestion space, such that elements with high density can spontaneously sink down and/or this process can be accelerated.

In some embodiments, the outlet of the tank which is intended for discharging elements with high density, definitively or indefinitively, is the lowest-lying outlet such that the aforementioned elements can sink to said outlet under the influence of gravity and can be discharged from the digestion space relatively simply.

In some embodiments, the distance between the outlets is such that the elements with high density are removed from the tank mainly via the lowest-lying outlet and the at least partly digested organic material low in or free from elements with high density can be obtained by higher-lying outlets from the digestion space.

The device can be provided with a mixing pump for mixing organic material to be digested with the at least partly digested organic material and/or with external inoculum and pumping the mixed mass via at least one inlet to the digestion space.

An aspect of this is that such inoculum can encourage the processing of the organic material.

In addition, the device can be provided with one or more recycling pipes which are intended to discharge the at least partly digested material to the mixing pump where the at least partly digested material is mixed with organic material to be digested and/or if relevant with external inoculum after which the mixture can be added to the tank for the processing thereof.

An aspect of this is that a relatively pure fraction, in other words at least partly digested organic material low in or free from elements with high density, can be obtained via the recycling outlets and/or the recycling pipes, intended to be used substantially as inoculum, as well as to be discharged for further processing if relevant, for example for the production of compost.

An additional aspect of this is that the at least partly digested material can be considered as inoculum for the organic material to be digested such that no or only a limited quantity of external inoculum needs to be added such that the device can thus be self-sufficient.

In some embodiments, the tank is provided with a gas outlet for removing biogas from the tank to maintain an optimum operation of the device.

In some embodiments, the tank is provided with a conical bottom to encourage the guidance of the elements with high density to the lowest-lying outlet.

In some embodiments, the device can be executed thus that the mixing pump, at regular intervals and if relevant automatedly, can pump at least partly digested material through one or several recycling pipes, either in the direction of the digestion space, or in the direction of the mixing pump.

An aspect of this is that the product stream through the recycling pipes created by the mixing pump can solve or prevent any blockages in the recycling outlets or the recycling pipes.

An additional aspect of this is that in the product stream created by the mixing pump along one or several recycling pipes and in case of simultaneous extraction via the lowest-lying outlet and/or via the other one or several recycling pipes a driving force may be generated which can accelerate the discharge of elements with high density along the lowest-lying outlet.

The present disclosure also relates to a method for processing organic material, whereby elements with high density are separated and a device as described above is used, said method containing the following steps:
providing a device;
supplying organic material via at least one inlet to the digestion space;
at least partly digesting the organic material in the digestion space;
extracting at least partly digested material low in or free from elements with high density via one or more recycling outlets;
discharging at least a part of the elements with high density via the residue outlet;
   whereby before supplying the organic material to the digestion space, the organic material is mixed with at least partly digested material and/or external inoculum in the mixing pump.

It is understood that the method of the device according to the present disclosure offers the same aforementioned aspects as the device for processing organic material.

The elements with high density can be removed from the digestion space via the lowest-lying outlet by an extraction system to thus minimise damage and wear and tear to the device.

This method offers the aspect that a reduced concentration of elements with high density can be obtained in the digestion space such that the risk of blockages and/or accumulations in the device decreases strongly and operational reliability of the device strongly increases.

### BRIEF DESCRIPTION OF THE DRAWINGS

With the intention of better showing the characteristics of the present disclosure, an embodiment of the device according to the present disclosure is described hereinafter, by way of an example without any limiting nature, and a method with reference to the accompanying drawings wherein:

FIG. 1 schematically shows a front view of a device according to the present disclosure;

FIG. 2 shows a cross-section according to line II-II in FIG. 1;

### DETAILED DESCRIPTION

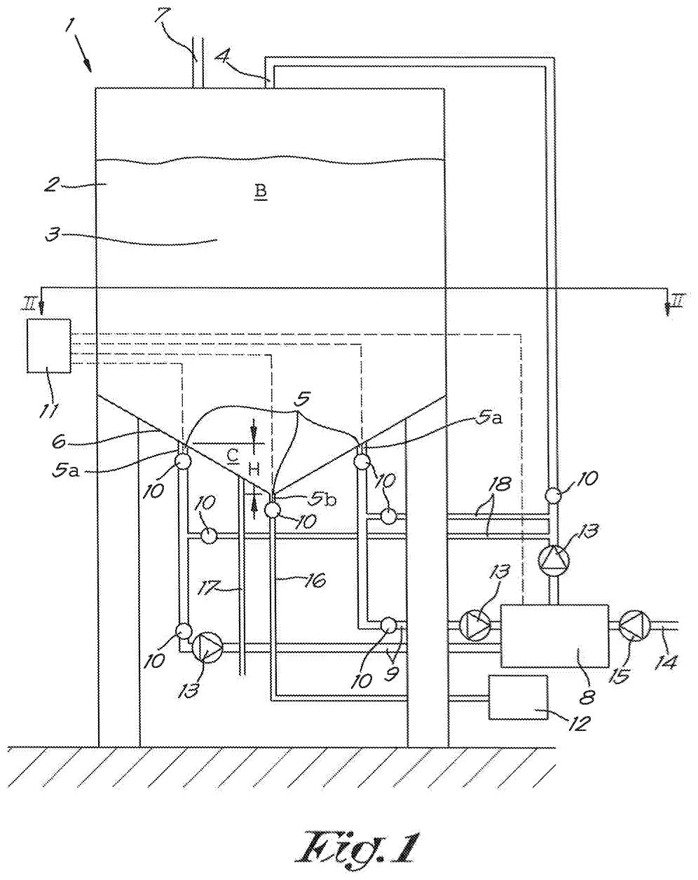

The device 1 shown in FIG. 1 is intended for processing organic material by anaerobic digestion, whereby indigestible elements can be separated from the device 1.

Organic material is understood to mean, among others, biodegradable waste that may or may not be liquid and in particular can be completely or partly composed of the organic fraction of domestic waste and/or food waste streams and/or agricultural crops and/or green waste and/or garden waste and/or the like.

The device shown in FIG. 1 contains a tank 2 with a digestion space 3 and an inlet 4 for supplying the organic material to be digested.

Typically, such material also contains indigestible elements with a relatively high density.

High density is understood to mean elements with a density that is at least 50%, 100%, or 150% higher that the density of the digestible waste and/or at least partly digested material in the tank 2.

In some embodiments, such tank 2 is closed at the top.

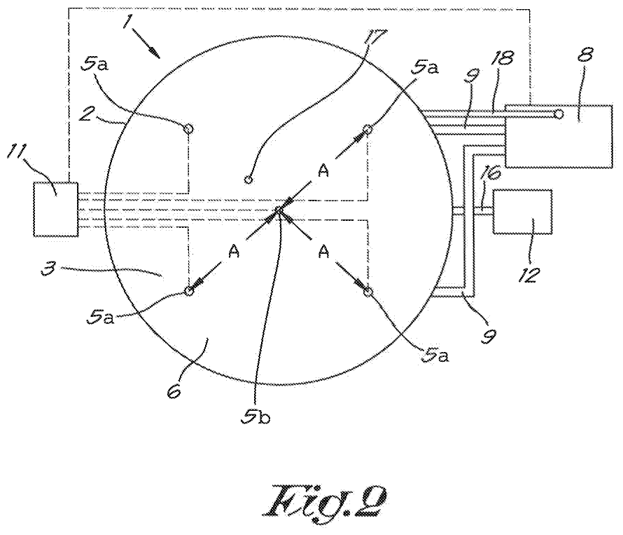

The device 1 is also provided with at least two sealable outlets 5, five outlets 5 in the case of FIGS. 1 and 2.

In some embodiments, the sealable outlets 5 of the tank 2 are each provided with a valve to be able to open and close the outlets 5 separately at will.

At least one outlet 5 of the tank 2 is intended for extracting the at least partly digested organic material from the digestion space 3, said outlet 5 being the recycling outlet 5a and at least one outlet 5 is intended for discharging at least a part of the elements with high density, said outlet 5 being the residue outlet 5b.

In this case extracting is understood to mean removing at least partly digested organic material from the digestion space 3, said material intended to be used substantially for reuse as inoculum.

In this case, discharging is understood to mean removing at least partly digested organic material and/or undigested material and/or elements with high density from the digestion space 3 which, definitively or indefinitively, are taken out of the device, possibly for further processing.

The purpose of discharging elements with high density is, among others, removing the elements from the tank 2 to reduce and/or prevent any damage to the tank 2 or other parts of the device 1.

Typically, when discharging elements with high density a limited quantity of at least partly digested mass is discharged in which the elements are present.

In some embodiments, the quantity of at least partly digested mass that is hereby discharged and thus would be lost is minimal.

The residue outlet 5b and the recycling outlets 5a are located at least at height H at a distance A from each other, whereby the residue outlet 5b is located at a lower level than the recycling outlets 5a.

In some embodiments, the distance A between the residue outlet 5b and the recycling outlets 5a is such that the elements with high density are mainly separated via the residue outlet 5b.

In some embodiments, the residue outlet 5b which substantially is intended for discharging elements with high density is thus the lowest-lying outlet.

In some embodiments, the tank 2 is provided with a conical bottom 6 whereby the residue outlet 5b is located centrally in the tip of the conical bottom 6.

The distance A between residue outlet 5b and the recycling outlets 5a may also mutually differ.

Thus, it is not necessary that the distance A and/or the height H between the residue outlet 5b and the recycling outlets 5a is the same.

The digestion space 3 can imaginably be divided into a zone B in which organic material to be digested and/or at least partly digested material is present with a lower concentration of elements with high density than on average in the digestion space 3 and a zone C with at least partly digested organic material with a higher concentration of elements with high density than on average in the digestion space 3, whereby the transition between zones B and C is located approximately on the level of the recycling outlets 5a.

In some embodiments, the tank 2 is also provided with a gas outlet 7 for removing biogas from the tank 2, said gas outlet 7 being located in the case of FIG. 1 close to the inlet 4 at the top of the tank 2.

Biogas is understood to mean the gas that is released when anaerobically digesting the organic waste.

The device 1 can be provided with a mixing pump 8 for mixing the organic material to be digested with at least partly digested material and/or with external inoculum and pumping the mixed mass via the inlet 4 to the digestion space 3 to process the mixed mass.

The at least partly digested material can also serve as inoculum, such that the device 1 can be self-sufficient in this respect.

In some embodiments, it is also possible to add water or other fluids to the at least partly digested material and/or material to be digested, on the level of the mixing pump 8, to change the viscosity of the mass to be mixed to the desired viscosity, for example a viscosity lower than that of the material to be digested and/or at least partly digested material in the digestion space 3.

Consequently, the elements with high density in the digestion space 3 can sink more quickly through the at least partly digested organic material in the direction of the residue outlet 5b, such that an optimum separation of the aforementioned elements can be obtained.

In addition it is also possible to add water or other fluids to the mass to be mixed on the level of the recycling pipes 9.

However, it is also possible that the desired viscosity is higher than that of the material in the digestion space 3.

To this end, the device 1 can also be provided with one or more recycling pipes 9, four recycling pipes 9 in the example of FIGS. 1 and 2, which are intended to discharge the at least partly digested material low in or free from elements with high density to the mixing pump 8 where the at least partly digested material is mixed with organic material to be digested after which the mixing pump 8 can pump the mixed mass to the digestion space 3.

Each recycling pipe 9 forms the connection between a recycling outlet 5a and the mixing pump 8 to discharge the at least partly digested material low in or free from elements with high density from the digestion space 3 to the mixing pump 8.

It is understood that the recycling outlets 5a can be connected to the mixing pump 8 in different ways and that the recycling pipes 9 can be realised in different ways as techniques that can move the at least partly digested organic material from and to the tank 2.

For extracting the at least partly digested material low in elements with high density the recycling pipes 9 can be provided with a discharge pump 13, for example one discharge pump 13 in each recycling pipe 9.

The device 1 may also be configured to determine the ratio of organic material to be digested to at least partly digested material, which is adjustable or can be regulated by a controller 11.

For example one or more flow meters 10 and/or one or more dosing systems for adding a fluid and/or material to be digested and/or the like.

Thus, the aforementioned recycling pipes 9 can be provided with a flow meter 10 for measuring the extracted flow, a flow meter 10 in each recycling pipe 9.

The device 1 main contain a controller 11 which is in contact with the aforementioned flow meters 10 and the sealable outlets, whereby the controller 11 can control the sealable outlets to open in order to partly or wholly extract the at least partly digested mass from the tank 2 and to close when a flow meter 10 indicates that the desired extracted flow has been extracted from the tank 2.

In some embodiments, the controller 11 is also connected to the mixing pump 8 and/or the discharge pumps 13, such that the controller 11 can control the mixing pump 8 and/or the discharge pumps 13 to supply the mixed mass and/or at least partly digested waste to the digestion space 3 and/or to the mixing pump 3.

The elements with high density can be removed from the digestion space 3 via the residue outlet 5b by an extraction system 12 and possibly be discharged for a separate post-treatment.

In some embodiments, to this end, the residue outlet 5b is connected to the aforementioned extraction system 12 by one or more residue pipes 16.

Said residue pipe 16 can be provided with the aforementioned flow meter 10 for measuring and possibly registering the flow of material that leaves the digestion space 3 via the residue outlet 5b.

The device 1 can also be provided with one or more discharge pipes 17 for discharging the content from the digestion space 3.

Such discharge pipes 17 can be connected to the digestion space 3 and/or to the mixing pump 8 and/or branch off from the recycling pipes 9 and/or branch off from the residue pipes 16 and/or return pipes 18.

The purpose of the aforementioned discharge pipes 17 is to discharge the content or a part thereof from the digestion space 3 and/or from the mixing pump 8 and/or the recycling pipes 9 and/or the residue pipes 16 and/or return pipes 18 to prevent or remove any blockages.

Such discharge pipes 17 can also be used to test the quality of the content or a part thereof and/or to test for any contaminations and/or quantity of indigestible elements and/or other tests that are desired.

In a practical embodiment the device 1 can also be provided with one or more return pipes 18 which form a connection between the mixing pump 8 and the recycling pipes 9, said return pipes 18 being intended to allow the mixed mass or a part thereof to flow through the recycling pipes 9, either in the direction of the digestion space 3, or in the direction of the mixing pump 8, to solve and/or avoid any blockages.

An additional aspect of this is that when simultaneously discharging elements with high density via the residue outlet 5b and supplying the mixed mass via one or more recycling pipes 9 and/or one or more recycling outlets 5a, a driving force may be created that can accelerate the discharge of the elements with high density via the residue outlet 5b and/or solve and/or avoid any blockages.

The aforementioned controller 11 may also control the mixing pump 8 to pump the mixed mass or a part thereof to the return pipes 18 and thus to one or more recycling pipes 9.

In some embodiments, the controller 11 will simultaneously control the mixing pump 8 to pump the mixed mass or a part thereof to the digestion space 3 via the return pipes 18 and to extract the at least partly digested material low in or free from elements with high density from the digestion space 3 along the one or more remaining recycling outlets 5a such that a flow can be created in the digestion space 3 between two or more recycling pipes 9 which in turn can create a driving force which can accelerate the discharge of the elements with high density via the residue outlet 5b and/or solve and/or prevent any blockages.

In some embodiments, the controller 11 is executed such that it controls the mixing pump 8 and/or the discharge pumps 13 at regular and/or predefined times to pump at least a part of the mixed mass and/or at least a part of the at least partly digested waste.

However, it is not necessary that the times are the same for pumping the mixed mass or a part thereof, definitively or indefinitively, and discharging the at least partly digested waste or a part thereof from the digestion space 3.

In some embodiments practical embodiment, the desired flow extracted via the recycling outlets 5a is equal to or practically equal to the flow that is added to the tank reduced with the quantity of produced biogas and the at least partly digested material that leaves the tank 2 via the gas outlet 7 and the residue outlet 5b.

In some embodiments, for processing organic material the device 1 uses anaerobic digestion, or dry digestion.

Dry digestion is understood to mean digestion of organic material whereby the at least partly digested organic material in the digestion space 3 typically contains a dry matter percentage of at least 18%, at least 15%, or at least 12%.

The minimum of the dry matter percentage of, for example, 12% is not defining in the context of this present disclosure and depends on the exact composition and/or structure and/or viscosity of the at least partly digested organic material and/or the like.

In some embodiments, the mixing pump 8 and/or the inlets 4 and/or the recycling pipes 9 and/or return pipes 18 and/or residue pipes 17 and/or their associated outlets 5b can be connected to each other and/or the tank 2 in different ways without departing from the scope of the present disclosure.

In a practical embodiment, the device 1 is or can be executed such that the at least partly digested material that would be lost when discharging elements with high density is collected and supplied as inoculum.

It is possible hereby that this at least partly digested material has been pre-treated for removing the elements with high density before it is reused as inoculum.

The present disclosure also relates to a method for processing organic material and separating elements with high density using a device as described above, said method containing the following steps:
providing a device 1 according to the present disclosure;
supplying organic material via an inlet 4 to the digestion space 3;
at least partly digesting the organic material in the digestion space 3;
extracting at least partly digested material low in or free from elements with high density via one or more recycling outlets 5a;
discharging at least a part of the elements with high density via the residue outlet 5b.

Before supplying the organic material to the digestion space 3, the organic material can be mixed with the at least partly digested material in the mixing pump 8 after which the mixed mass can be pumped to the digestion space 3.

In some embodiments, said organic waste can be supplied by a supply pipe 14 which ends in the mixing pump 8, said supply pipe 14 being provided with a supply pump 15.

It is also possible to supply external inoculum to the organic waste and/or the mixed mass to encourage the digestion of the organic waste and/or mixture.

In some embodiments, said external inoculum is directly supplied to the digestion space 3 or during the mixing in the mixing pump 8.

The at least partly digested material low in or free from elements with high density can be supplied to the mixing pump 8 from the digestion space 3 via recycling pipes 9 of the tank 2.

The at least partly digested material with high concentration of elements with high density that is removed from the digestion space 3 via the residue outlet 5b by an extraction system 12 may possibly be discharged for a separate post-treatment.

The present disclosure is not limited to the embodiments described as an example and shown in the figures, but a device according to the present disclosure and a method can be realised in all kinds of forms and dimensions without departing from the scope of the present disclosure.

1. A device for processing organic material, whereby the organic material may also contain elements with high density, the device being provided with a tank with a digestion space and an inlet for supplying the organic material to be processed, wherein the device is provided with at least two scalable outlets, wherein one or more of the at least two sealable outlets are recycling outlets configured to discharge the at least partly digested organic material and in that at least one of the at least two scalable outlets is a residue outlet configured to discharge at least a part of the indigestible elements with high density, the residue outlet being located on a lower level than the one or more recycling outlets and wherein the device contains a mixing pump for mixing the organic material to be digested with at least partly digested material and/or with external inoculum and for pumping a mixed mass via the inlet to the digestion space.

2. The device according to claim 1, wherein the at least one residue outlet configured to discharge elements with high density is a lowest-lying outlet.

3. The device according to claim 1, wherein a distance A and/or a height H between the at least two scalable outlets is such that the elements with high density are removed from the tank mainly via the residue outlet.

4. The device according to claim 1, wherein the device is provided with one or more recycling pipes which form a connection between the recycling outlets and the mixing pump, the recycling pipes configured to discharge at least partly digested material to the mixing pump where the at least partly digested material is mixed with organic material to be digested and/or with external inoculum.

5. The device according to claim 4, wherein the device is configured to determine a ratio of organic material to be digested to recycled at least partly digested material, which is adjustable or can be regulated by a controller.

6. The device according to claim 5, wherein the device is configured to add fluid with a lower viscosity than a viscosity of the material in the digestion space such that the viscosity of the material in the digestion space can be adjusted to thus accelerate the discharge of elements with high density from the residue outlet.

7. The device according to claim 6, wherein the one or more recycling pipes are provided with a flow meter for measuring an extracted flow.

8. The device according to claim 7, wherein the controller is in contact with the flow meter and the sealable outlets, the controller configured to control the sealable outlets to open in order to extract the at least partly or wholly digested mass from the tank and to close when the flow meter indicate that a desired extracted flow from the tank is obtained.

9. The device according to claim 1, wherein the tank is provided with at least one gas outlet for removing biogas from the tank.

10. The device according to claim 1, wherein anaerobic digestion is used for processing organic material.

11. The device according to claim 1, wherein the tank is provided with a conical bottom.

12. The device according to claim 1, wherein the device is provided with one or more return pipes which form a connection between the mixing pump and one or more recycling pipes such that the mixing pump can pump the at least partly digested material or a part thereof to the recycling pipes via the return pipes to solve any blockages and/or to accelerate the discharge of elements with high density.

13. A method for processing organic material and separating indigestible elements with high density using a device according to claim 1, the method comprises the following steps:
providing a device;
supplying organic material via at least one inlet to the digestion space;
at least partly digesting the organic material in the digestion space;
extracting the at least partly digested material low in or free from elements with high density via one or more recycling outlets;
discharging at least a part of the elements with high density via the residue outlet;
whereby before supplying the organic material to the digestion space, the organic material is mixed with at least partly digested material and/or external inoculum in the mixing pump.

14. The method according to claim 13, wherein the at least partly digested material low in or free from elements with high density is supplied from the tank to the mixing pump via recycling pipes.

15. The method according to claim 13, wherein elements with high density are removed from the digestion space via the residue outlet by an extraction system.

16. The method according to claim 15, wherein discharging elements with high density occurs regularly, either continuously, or discontinuously.

17. A device for processing organic material having high density elements, a density of the high density elements is at least 50% higher than a remainder of the organic material, the device comprising:
a tank having a digestion space and an inlet for supplying the organic material to be processed into the digestion space of the tank;
a sealable recycling outlet configured to discharge at least partly digested organic material;
a sealable residue outlet configured to discharge at least a part of indigestible elements including the high density elements, the sealable residue outlet being located below the sealable recycling outlet;
a mixing pump configured to mix a mixed mass of material and pump the mixed mass of material into the digestion space via the inlet, the mixed mass of material includes: i) organic material to be processed from a supply pipe and at least partly digested organic material discharged from the sealable recycling outlet, ii) the organic material to be processed from the supply pipe and external inoculum, or iii) the organic material to be processed from the supply pipe, the at least partly digested organic material discharged from the sealable recycling outlet, and the external inoculum.

18. The device according to claim 17, wherein the device further comprises a recycling pipe that connects the sealable recycling outlet and the mixing pump, the recycling pipe configured convey the at least partly digested material discharged from the sealable recycling outlet to the mixing pump.

19. The device according to claim 18, wherein the device further comprises:
a controller configured to control the mixing pump to control a supply of the mixed mass of material into the digestion space via the inlet.

20. The device according to claim 19, wherein the device further comprise:
a flow meter provided on the recycling pipe, the flow meter configured to measure a flow of the at least partly digested material discharged from the sealable recycling outlet,
wherein the controller is configured to control the sealable recycling outlet and the sealable residue outlet between an open position and a closed positon based on a signal from the flow meter.
